(19) United States
(12) Patent Application Publication
(10) Pub. No.: US 2004/0134745 A1
(43) Pub. Date: Jul. 15, 2004

(54) Reverse vending apparatus

(76) Inventor: John Woods, Armagh (GB)

Correspondence Address: Gregory J Lavorgna, Drinker Biddle & Reath, One Logan Square, 18th & Cherry Streets, Philadelphia, PA, 19103-6996, US

(21) Appl. No.: 10/477,093

(22) PCT Filed: May 9, 2002
(86) PCT No.: PCT/GB02/02070

(30) Foreign Application Priority Data
May 10, 2001 (GB) 0111343.0

(51) Int. Cl. G07F 7/02; G07F 7/10

(52) U.S. Cl. 194/210

(57) ABSTRACT

A reverse vending apparatus for plastic jars having a jar receiving station and a jar identification station, wherein the apparatus includes means for receiving and supporting a jar by or through the neck of the jar, is described. Use of the neck of a jar avoids the problem of how to receive and support the different shapes and configurations of jars. The reverse vending apparatus preferably includes a reward system, whereby following despatch of all the completed jars by the consumer, suitable means provide a reward and/or receipt confirming the number of points, tokens and/or money earned by the reverse vending of the consumer.

This invention relates to a reverse vending apparatus and a reverse vending method.

Protection of the environment has become a prime concern in recent years. The recycling of used containers is an important factor in the conservation effort. A wide range of machinery exists to enable the collection, disinfection and storage of recyclable materials such as paper, glass and aluminium.

In particular, reverse vending machinery is well known for the collection of round articles of regular shape such as aluminium and PET drink containers. Existing methods involve a pair of rollers facilitating the rotation of the drinks containers until the barcode thereon can be scanned. This enables identification of the container and assessment thereof. An appropriate award is given to the consumer based upon the number of containers received.

Plastic materials such as high density polyethylene are also heavily used and may be detrimental to the environment if not disposed of appropriately. Many such plastic jars, bottles, containers or cartons exist (hereinafter generally termed “jars”) including, but not limited to, milk containers, juice containers and containers for household detergents. These jars are often of an irregular shape. However the identification of the relevant jar is still required for the purpose of recycling. Identification of irregularly shaped objects cannot be carried out by present methods of reverse vending.

It is an object of the present invention to overcome these disadvantages.

According to one aspect of the present invention, there is provided a reverse vending apparatus for plastic jars having a jar receiving station and a jar identification station, wherein the apparatus includes means for receiving and supporting a jar by or through the neck of the jar.

Use of the neck of a jar avoids the problem of how to receive and support the different shapes and configurations of jars.

The means for receiving and supporting the jar can have any suitable shape, size or design. In one embodiment of the present invention, the means comprises a finger or other outwardly extending protrusion which is partly, substantially or wholly insertable in the neck of the jar. The means could be formed from any suitable material, either hard or soft, including plastic, rubber and/or metal. The means is preferably elongate, and may also be tapered towards the neck-insertable end.

Preferably, the apparatus of the present invention includes a plurality of such means, which plurality of means could be provided in series or parallel. Preferably, the means is/are part of a re-circular system such as a rotating platform or drum, or a conveyer-type arrangement such as on or around a looped system such as a conveyer belt. The means for receiving and supporting the jar may be wholly or partly moveable relative to the re-circular system. The re-circular system preferably transports the jar around and/or through each station of the apparatus.

According to another embodiment of the present invention, a jar is received and/or supported on the relevant means in a wholly or substantially vertical but upside-down position. This action assists drainage of any remaining liquid in the jar.

The jar identification station of the apparatus of the present invention can include one or more means adapted to identify a characteristic of a jar or an indice thereon. These include shape, configuration, printed indicia such as a barcode or a label, or other material on or as part of the jar.

According to another embodiment of the present invention, the jar is rotated one or more times at the jar identification station to ensure identification occurs by repetition of the showing of the identifier of the jar before the identification means.

Preferably, the jar is rotated about the neck of the jar. If a jar is elongate, the jar is preferably rotated about a longitudinal axis.

The jar can be identified using any suitable identification means such as a scanner.

Preferably, the jar receiving station included one or more doors, shutters, etc to prevent accidental interaction between the user and the inner parts, especially the mechanism, of the apparatus.

The jar receiving station and jar identification station are preferably separate. The apparatus preferably includes a jar pressing station to densify a jar, generally after its identification. The apparatus may also include a jar rejection station for rejection of undesired jars, and a jar collection station, possibly having a shreader or similar.

According to another embodiment of the present invention, the apparatus includes means to provide a reward to the user of the apparatus. The reward can be in any suitable means such as tokens, points, money etc, whose value can be related to the type of jar as identified in the jar identification station. The reward could be in the form of a direct or indirect charitable donation, or collective or other points scheme etc.

Generally the jars to be collected by the apparatus of the present invention are wholly or substantially plastic, especially the high density plastics commonly used for irregular shaped jars such as milk containers. HDPE is one such material.

According to a second aspect of the present invention, there is provided a method of reverse vending of jars comprising the steps of:

receiving and supporting a jar;

identifying the jar; and

collecting or rejecting the jar, wherein the jar is received and supported by or through the neck of the jar.

Preferably, the jar is received and supported by a means hereinbefore described, which transports the jar for its identification and collection and/or rejection. The transportion is preferably provided by a re-circular system as hereinbefore defined, and the jar is identified using a characteristic and/or indice as hereinbefore

Embodiments of the present invention will now be described by way of example only and with reference to the accompanying diagrammatic drawings in which

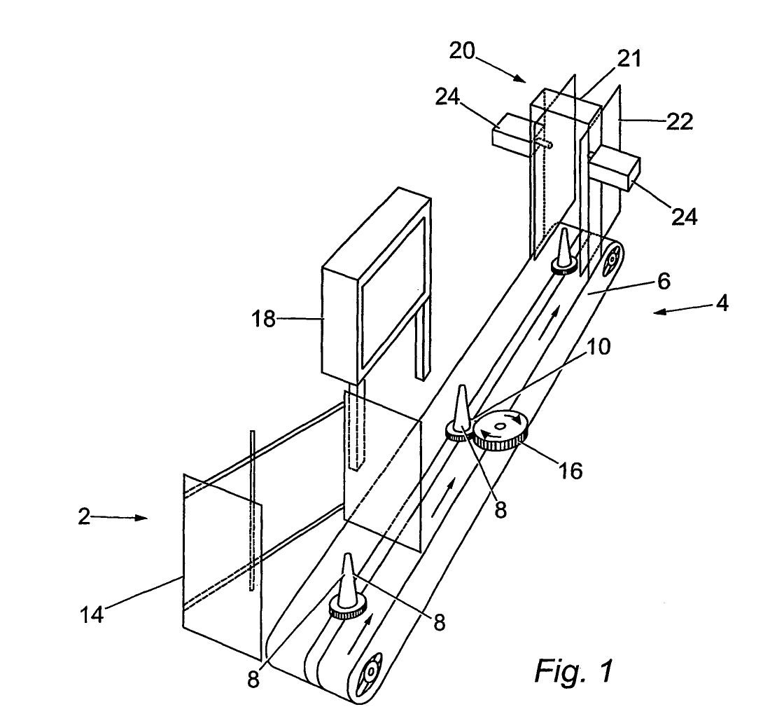

FIG. 1 is a perspective view of apparatus according to one embodiment of the present invention;

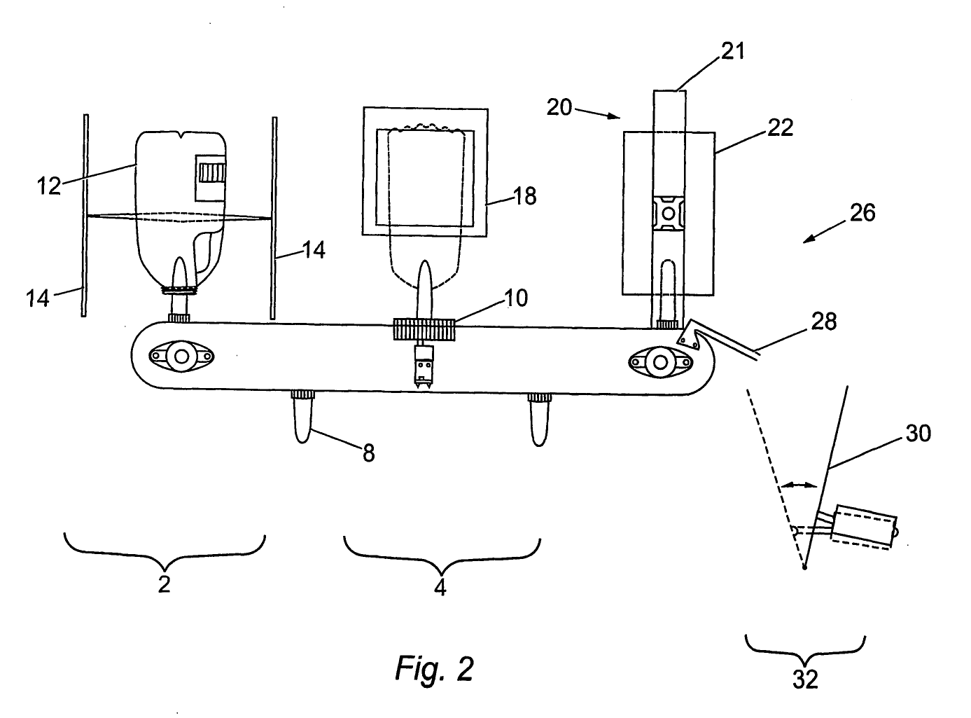

FIG. 2 is a side view of the apparatus of FIG. 1;

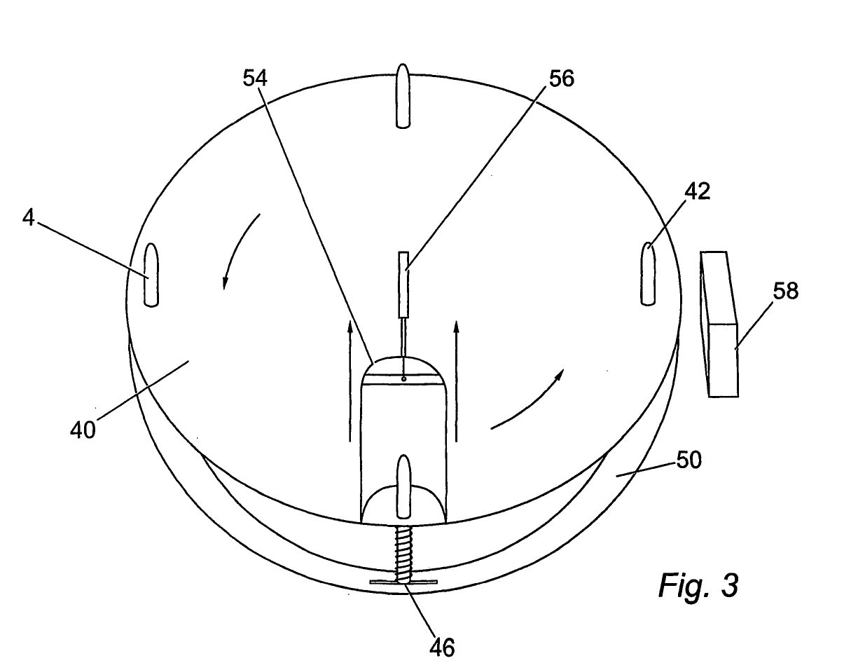

FIG. 3 is a perspective view of apparatus according to a second embodiment of the present invention; and

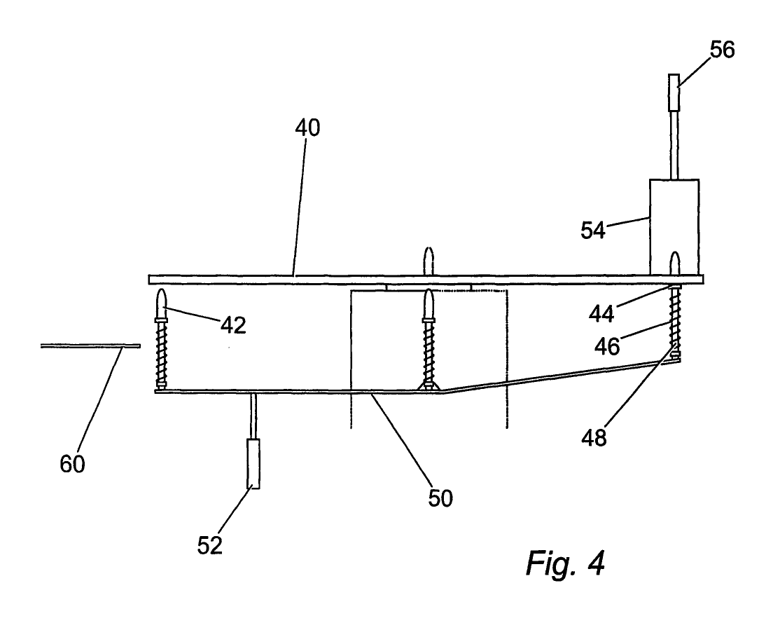

FIG. 4 is a side view of FIG. 3.

Referring to the drawings, FIG. 1 shows a first reverse vending apparatus having a jar receiving station 2 and a jar identification station 4.

The apparatus has a re-circular chain-driven conveyor, having a belt 6, e.g. one metre in length, with six (not all showing) hollow rubber cones (8) equidistant along the belt 6. Each cone 8 is mounted on a freely turning bearing to which a wheel 10 of e.g. 50 mm diameter, is fitted. The cones 8 could be approximately 70 mm long, generally tapering from e.g. 30 mm to 20 mm at the distal end.

At the jar receiving station 2, an empty HDPE jar 12, such as a two litre milk carton, can be loaded.

The conveyor-belt 6 preferably stops as the jar 12 is being received. For this purpose, sensors such as photocell lights (not shown) can be placed strategically across the conveyor belt 6 to coordinate operation and stopping of the conveyor belt 6. They can be used to activate safety doors 14 across the opening to the jar receiving station 2, and between the jar receiving station 2 and the jar identification station 4. Use of two safety doors 14 ensures a safety barrier between the user and the internal parts of the reverse vending apparatus.

Once the outer safety door 14 is fully closed, the conveyor belt 6 receives a suitable signal and moves the cone 8 and jar 12 to the jar identification station 4. At this point, the wheel 10 mounted on the bearing at the base of the cone 8 comes into contact with a motor driven wheel 16 directly opposite a laser barcode scanner means 18. The wheel 16 rotates the mounted wheel 10, so as to rotate the jar 12, generally three times. In this way, the scanner 18 is able to identify a suitable indice of the jar such as the barcode. Barcode scanners are well known in the art. The scanner can then establish unique identification of the jar 12.

Once the cone 8 with the jar 12 is at the jar identification station 4, another cone 8 is available at the jar receiving station 2 for receiving and supporting a second jar 12. The outer safety door 14 could open to indicate the readiness of the apparatus to receive another jar from a customer.

After the jar identification station 4, the apparatus has a jar pressing station 20, generally comprising a steel box frame 21 with two flat plates 22 closeable by means of horizontally mounted air cylinders 24. Activation of the air cylinders 24 presses the plates 22 to densify the jar 12 thereinbetween.

As shown in FIG. 2, the conveyor belt 6 can then move the flattened jar 12 to an unloading station 26. Here the cone 8 and flattened jar 12 travel around the far end of the conveyor belt 6 and suitable converging guides 28 mounted in the direction of the conveyor belt 6 causes the jar 12 to ease away and drop off the cone 8. The jar 12 then falls onto an air-operated plate door 30 mounted at a 45° angle, acting as a jar rejection station 32. If the laser scanner 18 obtained a positive reading of the barcode on the jar 12 at the jar identification station 4, the plate door 30 is operated to be in a position to allow the jar 12 to fall into a suitable collecting bin (not shown). If however the laser scanner 18 failed to obtain a suitable identification reading, it will signal the plate door 30 to move to a jar-rejection position (shown in dashed line) allowing the jar 12 to fall into a rejection bin (not shown).

An LED screen at a suitable location on the front of the apparatus could provide instructions and directions for use to the customer. Also, an opening or pocket could be provided in the front of the apparatus to separately collect any jar caps.

FIGS. 3 and 4 show the mechanism for a second reverse vending apparatus.

A 600 mm (all figures are approx) round turntable 40 is driven and rotated by a motor (not shown) mounted under the centre of the turntable 40. There are four round holes cut in the table (40) 30 mm in diameter and equi-distance apart, but 20 mm in from the outer rim of the table 40. These four holes in the turntable 40 are to allow the top of the rubber cones 42 to move up and down as required.

Beneath the table 40 are located four rubber cones 42, being similar to those described in the first apparatus of FIGS. 1a and 2. The cones 42 can rise through four holes in the turntable 40, the location of which is termed “Stations 1 to 4”. The turntable 40 is mounted inside the apparatus, but to the front centre of the vendor, and at 1400 mm from the floor of the vendor.

The rubber cones 42 are attached to a circular rubber wheel and bearing 44. The bearing is in turn attached to a steel ram (46) 150 mm long, 10 mm diameter. Near the lower end of the ram 46 two lugs are attached to retain a coil spring 48. The top of the coil spring 48 is attached to the underside of the table 40 but leaves enough clearance to allow the rubber cone 42 to rotate at Station 2. At the bottom end of the ram 46, a partly enclosed bearing of 25 mm diameter is mounted. The bearing runs on a circular fixed steel track 50 located 200 mm below the turntable 40, and at the same circle as the outside of the turntable 40 from Stations 1 to 3. The track 50 running from Station 3 to Station 4 is movable and attached to an air cylinder 52 below the track 50. This allows the track 50 between Station 3 and Station 4 to retract by 70 mm. The circular track between Station 4 and Station 1 therefore has a gradient rising from 270 mm below the table 40 to 200 mm as it reaches Station 1.

In use, the customer slides open a door at Station 1 and places the neck of an HDPE bottle (not shown) vertically and in an upside-down position over the rubber cone 42. The Station 1 is surrounded by a safety inner circular door 54, which is attached at the top to an air cylinder 56. When the customer places a bottle on the cone 42 and closes the door, the circular door 54 is lifted upwards by an air cyclinder 56 enough to clear the top of the bottle. The turntable 40 rotates that rubber cone 42 with the attached bottle to Station 2.

At Station 2, the rubber cone 42 with bottle attached is rotated by a small motor driven wheel (not shown) coming in contact with the base of the cone 42 to facilitate the reading of the barcode by a barcode reader 58. The turntable 40 then rotates the rubber cone 42 and bottle at Station 2 to Station 3. If the signal from the barcode reader 58 is a positive reading i.e. the barcode is an approved make or type, then the guide rail 50 between Stations 3 and 4 is retracted by 70 mm (as shown in FIG. 4) which in turn drops the spring cylinder and rubber cone 42 by a similar distance causing the bottle to be detached from the rubber cone 42, and so then causing the bottle to fall into a shredder or similar nearby.

The turntable 40 moves on to Station 4 with the top of the rubber cone 42 below the surface of the table 40. When the turntable 40 moves further between Stations 4 and 1, the track inclines from 270 mm below the table to 200 mm causing cylinder and rubber cone 42 to rise and the rubber cone 42 returns to Station 1 protruding 70 mm through the turntable 40. FIG. 4 also shows the position 60 of the track 50 before reaching Station 3.

If the barcode reader 58 at Station 2 does not recognise the barcode, this is classified as a “negative” bottle, and the turntable 40 moves to Station 3 where the track does not drop between Stations 3 and 4. Therefore, the reject bottle is carried to Station 4 and the cylinder arm and rubber cone then drop by 70 mm causing the reject bottle to fall into a reject section.

The above procedure is repeated for every bottle the customer presents to the vending apparatus. Both the reverse vending apparatus shown above preferably include a reward system, whereby following despatch of all the completed jars by the consumer, suitable means provide a reward and/or receipt confirming the number of points, tokens and/or money earned by the reverse vending of the consumer. The reward could be linked to the number and/or type of jars positively identified.

The reverse vending apparatus could be fitted with a modem and other telephone equipment required to telemetrically allow remote monitoring of each apparatus, so that a remote operator can be informed when the apparatus is full and/or broken. Such information also allows a controller to identify the volumes of jars collected in each apparatus, in a general area, and in relation to producers of jars.

The apparatus of the present invention preferably provides that the consumer can only return the empty jar by inverting it and placing it over the rubber cone. This assists in ensuring that no excessive contaminated liquids are returned therewith.

The apparatus of the present invention also preferably provides that no caps of such jars are returned with the returned jars.

The apparatus of the present invention provides a simple mechanism for the collection of previously difficult collectable jars. The present apparatus not only collects such jars, but is a simple means for selecting and segregating such jars, and of monitoring this.

1. A reverse vending apparatus for plastic jars having a jar receiving station and a jar identification station, wherein the apparatus includes means for receiving and supporting a jar by or through the neck of the jar.

2. Apparatus as claimed in claim 1 wherein the means for receiving and supporting the jar is an outwardly extending protrusion.

3. Apparatus as claimed in claim 2 wherein the means has an elongate shape.

4. Apparatus as claimed in any one of claims 1 to 3 wherein the means is partly, substantially or wholly insertable in the neck of the jar.

5. Apparatus as claimed in any one of the preceding claims wherein the means for receiving and supporting the jar is wholly or substantially formed from plastic and/or rubber.

6. Apparatus as claimed in any one of the preceding claims wherein the means tapers towards the neck-insertable end.

7. Apparatus as claimed in any one of the preceding claims wherein the means is movable between a jar supporting position and a jar non-supporting position.

8. Apparatus as claimed in any one of the preceding claims wherein the apparatus includes a plurality of means for receiving and supporting a jar.

9. Apparatus as claimed in any one of the preceding claims wherein the or each means is provided in a re-circular system.

10. Apparatus as claimed in claim 9 wherein the re-circular system is a conveyor type arrangement.

11. Apparatus as claimed in claim 9 wherein the re-circular system is a rotating platform.

12. Apparatus as claimed in any one of the preceding claims wherein a jar is received and/or supported on the relevant means in a wholly or substantially vertical and upside-down position.

13. Apparatus as claimed in any one of the preceding claims wherein the jar identification station includes one or more means adapted to identify a characteristic of the jar or an indice on the jar.

14. Apparatus as claimed in claim 13 wherein the indice on the jar is a barcode or label.

15. Apparatus as claimed in claim 13 or claim 14 wherein the means to identify is a scanner.

16. Apparatus as claimed in any one of the preceding claims wherein the jar is roatatable one or more times at the jar identification station about a longitudinal axis.

17. Apparatus as claimed in any one of the preceding claims wherein the jar receiving station has one or more safety doors.

18. Apparatus as claimed in any one of the preceding claims wherein includes a jar pressing station to densify a jar.

19. Apparatus as claimed in any one of the preceding claims wherein the apparatus includes a jar rejection station for rejection of undesired jars, and a jar collection station.

20. Apparatus as claimed in any one of the preceding claims wherein the apparatus includes means to provide a reward to the user of the apparatus.

21. Apparatus as claimed in claim 20 wherein the reward is a monetary piece or a monetary piece substitute.

22. Apparatus as claimed in any one of the preceding claims wherein the jar is wholly or substantially formed from HDPE.

23. Apparatus as claimed in any one of the preceding claims wherein the jar is a milk container.

24. A method of reverse vending of jars comprising the steps of:
receiving and supporting a jar;
identifying the jar; and
collecting or rejecting the jar, wherein the jar is received and supported by or through the neck of the jar.

25. A reverse vending apparatus substantially as hereinbefore defined and as shown in FIGS. 1 and 2.

26. A reverse vending apparatus substantially as hereinbefore defined and as shown in FIGS. 3 and 4.
